(19) United States
(12) Patent Application Publication
(10) Pub. No.: US 2022/0115677 A1
(43) Pub. Date: Apr. 14, 2022

(54) FUEL CELL SYSTEM AND CONTROL METHOD OF FUEL CELL SYSTEM

(71) Applicant: TOYOTA JIDOSHA KABUSHIKI KAISHA, Toyota-shi (JP)

(72) Inventor: Hiroyuki SUGANUMA, Aichi-gun (JP)

(73) Assignee: TOYOTA JIDOSHA KABUSHIKI KAISHA, Toyota-shi (JP)

(21) Appl. No.: 17/450,284

(22) Filed: Oct. 7, 2021

(30) Foreign Application Priority Data
Oct. 12, 2020 (JP) 2020-171676

(51) Int. Cl. H01M 8/04111; H01M 8/0438; H01M 8/04746

(52) U.S. Cl. CPC H01M 8/04111; H01M 2250/20; H01M 8/04746; H01M 8/0438

(57) ABSTRACT

A fuel cell system includes: a fuel gas supply flow path for supplying fuel gas from a fuel gas supply source to a fuel cell; a fuel gas circulation flow path for circulating fuel off-gas to the fuel gas supply flow path; a turbopump disposed in the fuel gas circulation flow path and configured to pressurize and feed the fuel off-gas to the fuel gas supply flow path by rotating in a first rotational direction; an ejector disposed in the fuel gas supply flow path and configured to merge the fuel gas and the fuel off-gas pressurized and fed by the turbopump and to supply merged gas to the fuel cell; and a controller configured to control rotation of the turbopump. The controller rotates the turbopump in a second rotational direction in the case of increasing a pressure in the fuel cell to a predetermined pressure using the fuel gas.

### CROSS REFERENCE TO RELATED APPLICATIONS

This application claims priority to Japanese Patent Application No. 2020471676, filed Oct. 12, 2020, the disclosure of which is incorporated by reference herein in its entirety.

### BACKGROUND

### Field

The present disclosure relates to a fuel cell system and a control method of a fuel cell system.

### Related Art

JP-A-2009-283171 discloses a fuel cell system that includes a hydrogen supply flow path for supplying hydrogen gas from a hydrogen tank to a fuel cell, and a hydrogen circulation flow path for returning hydrogen off-gas discharged from the fuel cell to the hydrogen supply flow path. In this fuel cell system, the hydrogen supply flow path is provided with an ejector. The ejector merges the hydrogen gas supplied from the hydrogen tank and the hydrogen off-gas discharged from the fuel cell, and supplies the merged gas obtained after the merging to the fuel cell. Meanwhile, the hydrogen circulation flow path is provided with a hydrogen pump that feeds the hydrogen off-gas discharged from the fuel cell to the ejector.

PATENT DOCUMENT 1: JP-A-2009-283171

In the fuel cell system described in JP-A-2009-283171 above, the negative pressure generated by the ejector can suck hydrogen off-gas from the hydrogen pump into the ejector, thus making it possible to reduce the power consumption of the hydrogen pump for circulating the hydrogen off-gas to the hydrogen supply flow path. However, in a case where the hydrogen pump is a turbopump, hydrogen off-gas may circulate through a gap in the hydrogen pump due to the negative pressure generated by the ejector even if the rotation of the hydrogen pump is stopped. For this reason, it will take a longer time to increase the pressure in the fuel cell when intended to increase it to a predetermined pressure by supplying the hydrogen gas from the hydrogen tank into the fuel cell, such as when power generation in the fuel cell is started under a low temperature environment, for example.

### SUMMARY

According to one aspect of the present disclosure, a fuel cell system is provided. The fuel cell system includes: a fuel cell; a fuel gas supply flow path for supplying fuel gas from a fuel gas supply source to the fuel cell; a fuel gas circulation flow path for circulating fuel off-gas discharged from the fuel cell to the fuel gas supply flow path; a turbopump disposed in the fuel gas circulation flow path and configured to pressurize and feed the fuel off-gas to the fuel gas supply flow path by rotating in a first rotational direction; an ejector disposed in the fuel gas supply flow path and configured to merge the fuel gas and the fuel off-gas pressurized and fed by the turbopump and to supply merged gas to the fuel cell; and a controller configured to control rotation of the turbopump. The controller rotates the turbopump in a second rotational direction opposite to the first rotational direction in a case of increasing a pressure in the fuel cell to a predetermined pressure using the fuel gas.

### BRIEF DESCRIPTION OF THE DRAWINGS

FIG. 1 is an explanatory diagram illustrating a schematic configuration of a fuel cell system of a first embodiment;

FIG. 2 is a cross-sectional view illustrating a configuration of an ejector of the first embodiment;

FIG. 3 is a cross-sectional view illustrating a configuration of a fuel pump of the first embodiment;

FIG. 4 is a flowchart illustrating the contents of an in-cell pressurization control of the first embodiment;

FIG. 5 is an explanatory diagram illustrating the state of a reverse rotation mode of the fuel pump of the first embodiment;

FIG. 6 is a time chart schematically illustrating changes in the in-cell pressure in the first embodiment;

FIG. 7 is a flowchart illustrating the contents of an in-cell pressurization control of a second embodiment;

FIG. 8 is a time chart schematically illustrating changes in the in-cell pressure in the second embodiment;

FIG. 9 is a cross-sectional view illustrating a configuration of a fuel pump of a third embodiment;

FIG. 10 is an explanatory diagram illustrating the state of a reverse rotation mode of the fuel pump of the third embodiment;

FIG. 11 is a cross-sectional view taken along the line XI-XI in FIG. 9;

FIG. 12 is a cross-sectional view illustrating a configuration of a fuel pump of a fourth embodiment; and

FIG. 13 is a cross-sectional view illustrating a configuration of a fuel pump of a fifth embodiment.

### DETAILED DESCRITION

A. First Embodiment:

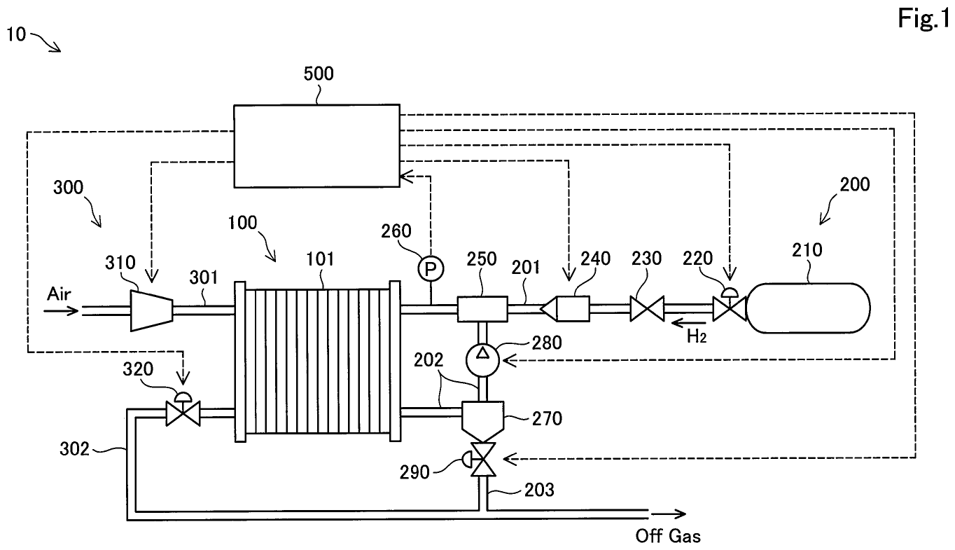

FIG. 1 is an explanatory diagram illustrating a schematic configuration of a fuel cell system 10 in a first embodiment. The fuel cell system 10 includes a fuel cell 100, a fuel gas supply and discharge unit 200, an air supply and discharge unit 300, and a controller 500. The fuel cell system 10 is installed in, for example, a fuel cell vehicle, and used as a power generator to supply power to a motor for driving the fuel cell vehicle. The fuel cell system 10 may be used as a stationary power generator to supply power to residences and the like.

In the present embodiment, the fuel cell 100 is a solid polymer fuel cell. The fuel cell 100 has a stack structure in which a plurality of unit cells 101 are stacked. Each unit cell 101 includes: a membrane electrode assembly having an electrocatalyst layer on both surfaces of an electrolyte membrane; and a pair of separators arranged to sandwich the membrane electrode assembly therebetween. Fuel gas is supplied between a part of the membrane electrode assembly on an anode electrode side and the separator, while air is supplied between a part of the membrane electrode assembly on a cathode electrode side and the separator. Each unit cell 101 generates power through an electrochemical reaction using the fuel gas and the air. In the present embodiment, hydrogen is used as the fuel gas. Methanol may also be used as the fuel gas. The fuel cell 100 may not be a solid polymer fuel cell, but a solid oxide fuel cell.

The fuel gas supply and discharge unit 200 supplies the fuel gas to the fuel cell 100 and discharges fuel off-gas from the fuel cell 100. The fuel off-gas contains the fuel gas and the like that have not been consumed by the power generation in the fuel cell 100. In the present embodiment, the fuel gas supply and discharge unit 200 includes a fuel gas supply flow path 201, a fuel gas circulation flow path. 202, a fuel gas discharge flow path 203, a fuel tank 210, a main stop valve 220, a regulator 230, an injector 240, an ejector 250, a pressure sensor 260, a gas-liquid separator 270, a circulation pump 280, and an exhaust drain valve 290.

The fuel tank 210 is a supply source of the fuel gas which is supplied to the fuel cell 100. The fuel tank 210 has the fuel gas stored therein. The fuel gas supply flow path 201 is a flow path for supplying the fuel gas from the fuel tank 210 to the fuel cell 100. The fuel gas supply flow path 201 is composed of a pipe provided between the fuel tank 210 and a fuel gas supply port of the fuel cell 100.

The fuel gas supply flow path 201 is provided with the main stop valve 220, the regulator 230, the injector 240, the ejector 250, and the pressure sensor 260 in this order. The main stop valve 220 switches between starting and stopping of the supply of the fuel gas from the fuel tank 210. The regulator 230 reduces the pressure of the fuel gas supplied from the fuel tank 210. The injector 240 injects the fuel gas, which is depressurized by the regulator 230, toward the ejector 250. The ejector 250 merges the fuel gas supplied from the injector 240 and the fuel off-gas supplied from the circulation pump 280 to be described below, and then supplies the merged gas to the fuel cell 100. The pressure sensor 260 measures the pressure of the gas in the fuel gas supply flow path 201 between the ejector 250 and the fuel gas supply port of the fuel cell 100. The information about the pressure measured by the pressure sensor 260 is transmitted to the controller 500.

The fuel gas circulation flow path 202 is a flow path for circulating the fuel off-gas discharged from the fuel cell 100, to the fuel gas supply flow path 201. The fuel gas circulation flow path 202 is composed of a pipe provided between a fuel gas discharge port of the fuel cell 100 and the ejector 250. The fuel gas circulation flow path 202 is provided with the gas-liquid separator 270 and the circulation pump 280. The gas-liquid separator 270 separates water from the fuel off-gas discharged from the fuel cell 100. The circulation pump 280 pressurizes and feeds the fuel off-gas, from which water has been separated by the gas-liquid separator 270, to the ejector 250. The fuel off-gas circulated to the ejector 250 is reused for power generation in the fuel cell 100.

The fuel gas discharge flow path 203 is a flow path for discharging the fuel off-gas or water separated by the gas-liquid separator 270 to the outside of the fuel cell system 10. The fuel gas discharge flow path 203 is composed of a pipe provided between the gas-liquid separator 270 and an air discharge flow path 302 to be described below. The fuel gas discharge flow path 203 is provided with the exhaust drain valve 290. The exhaust drain valve 290 switches between starting and stopping of the discharge of the fuel off-gas or water from the gas-liquid separator 270.

The air supply and discharge unit 300 supplies air to the fuel cell 100 and discharges air off-gas from the fuel cell 100. The air off-gas contains nitrogen, oxygen not consumed by the power generation in the fuel cell 100, water produced by the power generation in the fuel cell 100, and the like. The air supply and discharge unit 300 includes an air supply flow path 301, the air discharge flow path 302, an air compressor 310, and a pressure regulating valve 320.

The air supply flow path 301 is a flow path for supplying air to the fuel cell 100. The air supply flow path 301 is composed of a pipe. The air supply flow path 301 has one end thereof communicating with the atmosphere, and the other end thereof connected to an air supply port of the fuel cell 100. The air compressor 310 is provided in the air supply flow path 301. The air compressor 310 pressurizes and feeds air into the fuel cell 100.

The air discharge flow path 302 is a flow path for discharging the air off-gas to the outside of the fuel cell system 10. The air discharge flow path 302 is composed of a pipe. The air discharge flow path 302 has one end thereof connected to an air discharge port of the fuel cell 100 and the other end thereof communicating with the atmosphere. The fuel gas discharge flow path 203 is connected to the air discharge flow path 302. The pressure regulating valve 320 is provided in the air discharge flow path 302 between the air discharge port of the fuel cell 100 and a connection portion of the air discharge flow path 302 with the fuel gas discharge flow path 203. The pressure regulating valve 320 regulates the pressure of air in the fuel cell 100.

The controller 500 is configured as a computer that includes a CPU, a memory, and an input/output interface. The controller 500 controls the power generation in the fuel cell 100 by controlling the main stop valve 220, the injector 240, the circulation pump 280, the exhaust drain valve 290, the air compressor 310, and the pressure regulating valve 320. In the present embodiment, the controller 500 executes the in-cell pressurization control described below in the case of increasing the pressure of each unit cell 101 of the fuel cell 100 to a predetermined pressure using the fuel gas.

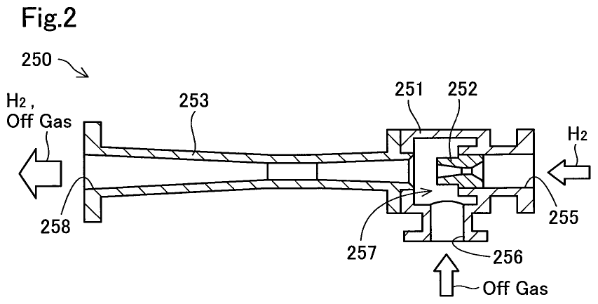

FIG. 2 is a cross-sectional view illustrating a configuration of the ejector 250. The ejector 250 includes a box-shaped body 251, a cylindrical nozzle 252 provided in the body 251, and a cylindrical diffuser 253 connected to the body 251.

The body 251 is provided with an inlet 255 that communicates with the injector 240, a suction port 256 that communicates with the circulation pump 280, and a suction chamber 257 that communicates with the suction port 256. The nozzle 252 causes the inlet 255 to communicate with the suction chamber 257. One end of the diffuser 253 communicates with the suction chamber 257, while the other end of the diffuser 253 is provided with a discharge port 258 that communicates with the fuel gas supply port of the fuel cell 100.

The fuel gas introduced through the inlet 255 is injected from the nozzle 252 toward the diffuser 253. Since the inner diameter of the nozzle 252 is smaller than that of the inlet 255, the fuel gas supplied to the nozzle 252 is accelerated and depressurized within the nozzle 252. As the fuel gas accelerated in the nozzle 252 is injected from the nozzle 252, negative pressure is generated in the suction chamber 257, causing fuel off-gas to be sucked from the suction port 256 into the suction chamber 257. The fuel off-gas sucked into the suction chamber 257 merges with the fuel gas injected from the nozzle 252, and the merged gas is then supplied to the diffuser 253. Since the inner diameter of the diffuser 253 is larger than that of the nozzle 252 and is widened gradually toward the discharge port 258, a merged gas of the fuel gas and fuel off-gas is decelerated and has its pressure increased in the diffuser 253, and is then discharged from the discharge port 258.

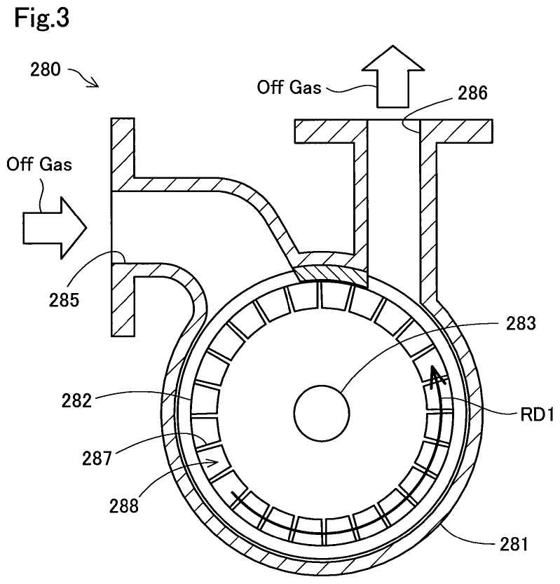

FIG. 3 is a cross-sectional view illustrating a configuration of the circulation pump 280. In the present embodiment, the circulation pump 280 is a vortex pump, which is classified as a turbopump. The circulation pump 280 includes a casing 281, an impeller 282 housed in the casing 281, and a shaft 283 connected to the impeller 282. The circulation pump 280 has a forward rotation mode and a reverse rotation mode as operation modes. As illustrated in FIG. 3, in the forward rotation mode, the impeller 282 rotates in a first rotational direction RD1, whereas in the reverse rotation mode, the impeller 282 rotates in the opposite direction to the first rotational direction RD1.

The casing 281 is provided with an inlet port 285 that communicates with the gas-liquid separator 270, and a discharge port 286 that communicates with the suction port 256 of the ejector 250. The impeller 282 is configured in a disk shape. The impeller 282 has, at its outer periphery, a plurality of guide vanes 287 provided radially and grooves 288 provided between the guide vanes 287. The shaft 283 is connected to a motor that is driven under the control of the controller 500. A rotational force generated by the motor causes the shaft 283 to rotate together with the impeller 282.

When the circulation pump 280 is operated in the forward rotation mode, the fuel off-gas is introduced into the casing 281 from the inlet port 285. The fuel off-gas introduced into the casing 281 is repeatedly pressurized by flowing through a gap between the grooves 288 of the impeller 282 and the casing 281 while forming a vortex, and is then discharged from the discharge port 286. As the fuel gas is injected from the injector 240 into the ejector 250 when the circulation pump 280 is operated in the forward rotation mode, the fuel off-gas discharged from the discharge port 286 is sucked into the ejector 250. Thus, by providing the ejector 250, the power consumption by the motor in the forward rotation mode can be reduced.

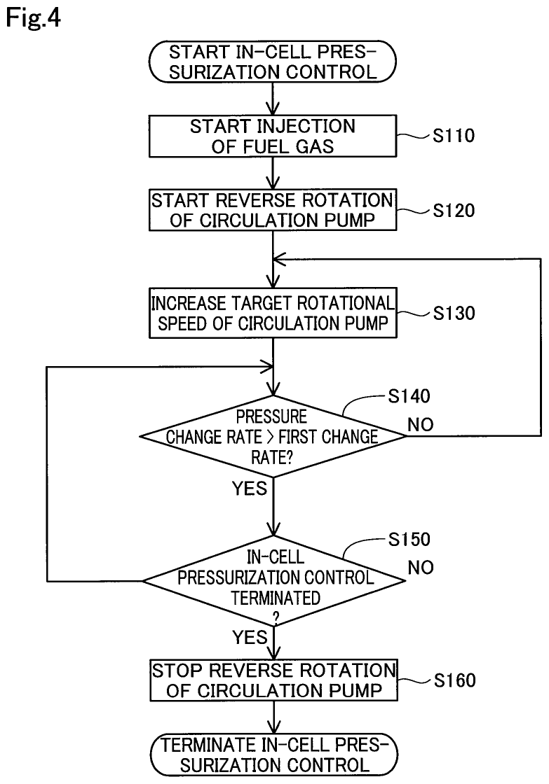

FIG. 4 is a flowchart illustrating the contents of an in-cell pressurization control. This process is executed by the controller 500 in the case of increasing the pressure in the unit cell 101 to a predetermined target value of pressure using the fuel gas. The controller 500 increases the pressure in the unit cell 101 to the predetermined target value of the pressure using the fuel gas, for example, when starting power generation in the fuel cell 100 under a low-temperature environment. The target value of the pressure is higher than the pressure in the unit cell 101 when the power generation of the fuel cell 100 is performed while rotating the circulation pump 280 in the first rotational direction RD1. While this process is being executed, the exhaust drain valve 290 remains in a closed state.

First, in step S110, the controller 500 starts injection of the fuel gas from the injector 240. In the present embodiment, the controller 500 causes the injector 240 to inject the fuel gas at a constant injection amount while this control is being executed. The injection amount of the fuel gas is determined based on the target value of the pressure in the unit cell 101 and a target value of an amount of power generation in the fuel cell 100.

Then, in step S120, the controller 500 starts the operation of the circulation pump 280 in the reverse rotation mode, and in step S130, the controller 500 increases a target value of a rotational speed of the circulation pump 280 in a second rotational direction RD2 by a predetermined amount.

Thereafter, in step S140, the controller 500 determines whether an in-cell pressure change rate, which is the. rate of change in the pressure of the gas in the unit cell 101, exceeds a predetermined first change rate. The first change rate can be determined by a test performed in advance. In order to increase the pressure in the unit cell 101 in a short period of time, it is preferable that the first change rate is determined to be a relatively high value. In the present embodiment, the controller 500 uses the pressure measured by the pressure sensor 260 as the pressure of the fuel gas in the unit cell 101. The controller 500 measures the pressure with the pressure sensor 260 multiple times at predetermined time intervals and calculates, for example, an average change rate of the pressure measured in one second. If the calculated average change rate of the pressure exceeds the first change rate, the controller 500 determines that the in-cell pressure change rate exceeds the first change rate.

If the in-cell pressure change rate is not determined to exceed the first change rate in step S140, the controller 500 returns to the process in step S130 to increase the target value of the rotational speed of the circulation pump 280 in the second rotational direction RD2 by the predetermined amount. In the present embodiment, the controller 500 increases the rotational speed of the circulation pump 280 by the same amount as the previously increased amount. In other embodiments, the controller 500 may increase the rotational speed of the circulation pump 280 by an amount greater than the previously increased amount, or by an amount less than the previously increased amount.

Until the in-cell pressure change rate is determined to exceed the first change rate in step S140, the controller 500 repeatedly performs the processes from step S130 to step S140. If the in-cell pressure change rate is not determined to exceed the first change rate in step S140 even after a predetermined time has elapsed, the controller 500 may determine that an error has occurred, stop the rotation of the circulation pump 280, and then terminate this process.

If the in-cell pressure change rate is determined to exceed the first change rate in step S140, the controller 500 determines whether the in-cell pressurization control is to be terminated in step S150. For example, if the pressure measured by the pressure sensor 260 exceeds the above-described target value of the pressure, the controller 500 determines to terminate the in-cell pressurization control.

If the in-cell pressurization control is not determined to be terminated in step S150, the controller 500 returns to the process in step S140 to determine whether the in-cell pressure change rate exceeds the predetermined first change rate. That is, the controller 500 determines whether the state in which the in-cell pressure change rate exceeds the first change rate is maintained. The controller 500 repeatedly performs the processes from step S140 to step S150 until the in-cell pressurization control is determined to be terminated in step S150.

If the in-cell pressurization control is determined to be terminated in step S150, the controller 500 stops the rotation of the circulation pump 280 in step S160, and then terminates this process. If the in-cell pressurization control is not determined to be terminated in step S150 even after a predetermined time has elapsed, the controller 500 may determine that an error has occurred, stop the rotation of the circulation pump 280, and then terminate this process.

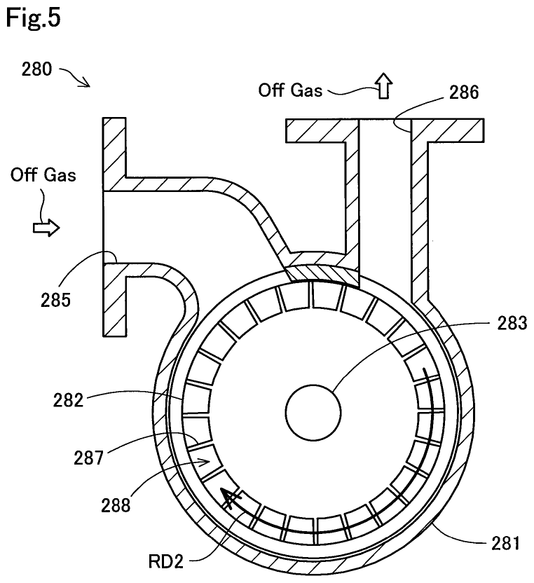

FIG. 5 is an explanatory diagram illustrating the state in which the circulation pump 280 is operated in the reverse rotation mode under the in-cell pressurization control. Negative pressure is generated in the suction chamber 257 of the ejector 250 by the injection of the fuel gas from the injector 240. As the circulation pump 280 is stopped while increasing the pressure in the unit cell 101 to the predetermined target value of the pressure, a circulating flow of fuel off-gas from a fuel gas discharge port of the fuel cell 100 toward the ejector 250 is generated through a gap between the casing 281 and the impeller 282. When the circulating flow of fuel off-gas is generated, it becomes difficult to confine the fuel gas supplied from the fuel gas supply port of the fuel cell 100 in the unit cell 101, and thus it takes a long time to increase the pressure in the unit cell 101 using the fuel gas. In the present embodiment, as illustrated in FIG. 5, the controller 500 operates the circulation pump 280 in the reverse rotation mode by executing the in-cell pressurization control in the case of increasing the pressure in the unit cell 101 to the predetermined target value of the pressure. In the reverse rotation mode, the impeller 282 rotates in the second rotational direction RD2. As the impeller 282 rotates in the second rotational direction RD2, the circulating flow of the fuel off-gas can be stopped or reduced.

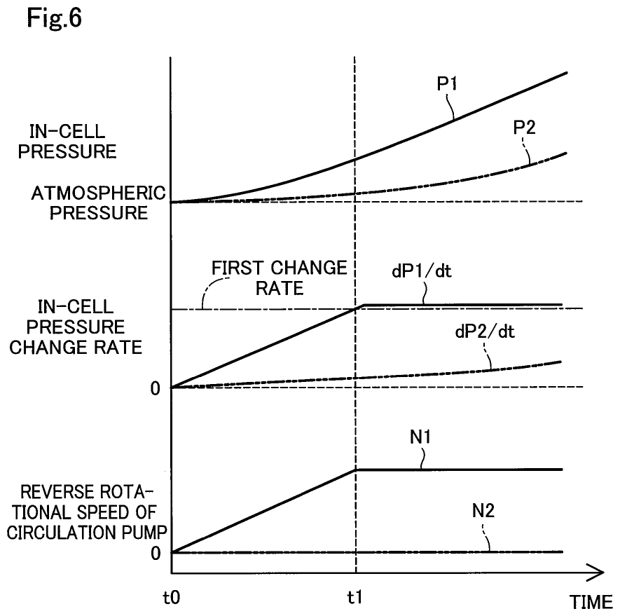

FIG. 6 is a time chart schematically illustrating changes in the in-cell pressure exhibited when executing the in-cell pressurization control. The solid lines in FIG. 6 represent the transitions of an in-cell pressure P1, of an in-cell pressure change rate dP1/dt, and of a rotational speed N1 of the circulation pump 280 in the second rotational direction RD2 when executing the in-cell pressurization control in the case of increasing the pressure in the unit cell 101 to the predetermined target value of the pressure. The dashed-two dotted line in FIG. 6 represent the transitions of an in-cell pressure P2, of an in-cell pressure change rate dP2/dt, and of a rotational speed N2 of the circulation pump 280 in the second rotational direction RD2 when stopping the rotation of the circulation pump 280 in the case of increasing the pressure in the unit cell 101 to the predetermined target value of the pressure. Since the circulating flow of the fuel off-gas is stopped or reduced when executing the in-cell pressurization control in the case of increasing the pressure in the unit cell 101 to the predetermined target value of the pressure, the in-cell pressure P1 is increased in a short period of time, compared to the case of stopping the rotation of the circulation pump 280.

According to the fuel cell system 10 of the present embodiment described above, the controller 500 executes the in-cell pressurization control, thereby causing the circulation pump 280 to rotate in the second rotational direction RD2 in the case of increasing the pressure of the unit cell 101 of the fuel cell 100 to the predetermined target value of the pressure using the fuel gas injected from the injector 240. Such rotation of the circulation pump 280 in the second rotational direction RD2 can stop or reduce the circulating flow of the fuel off-gas due to the negative pressure generated by the ejector 250 when the fuel gas is injected from the injector 240. Thus, the time required to increase the pressure in the unit cell 101 can be shortened.

Further, in the present embodiment, the controller 500 increases the rotational speed N1 of the circulation pump 280 in the second rotational direction RD2 until the in-cell pressure change rate dP1/dt exceeds the first change rate in the in-cell pressurization control, which can suppress the shortage of the rotational speed N1 of the circulation pump 280 for stopping or reducing the circulating flow of the fuel off-gas. Thus, the pressure in the unit cell 101 can be effectively increased. In particular, in the present embodiment, the in-cell pressure change rate dP1/dt can be increased surely, compared to the form in which the rotational speed N1 of the circulation pump 280 is controlled independently of the in-cell pressure change rate dP1/dt.

B. Second Embodiment:

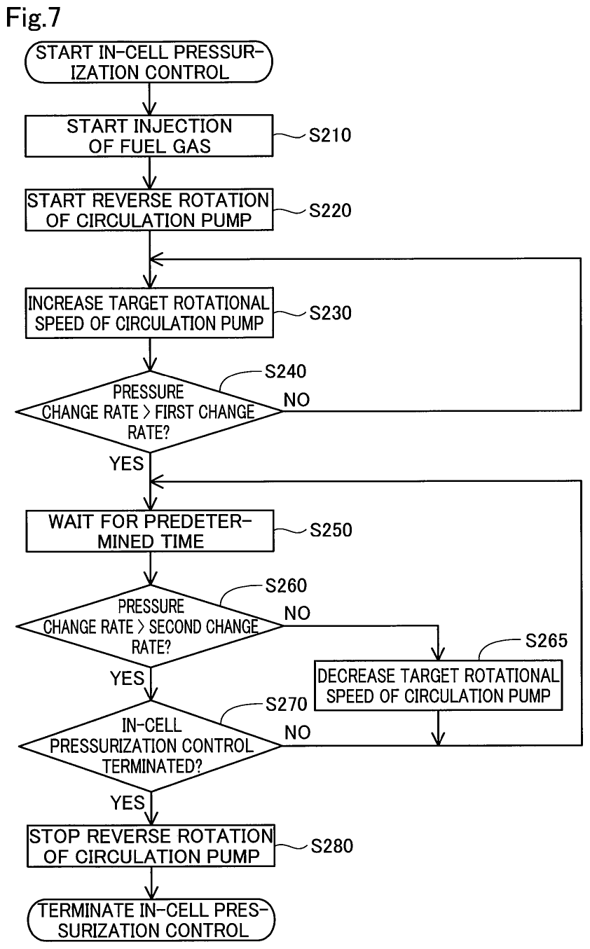

FIG. 7 is a flowchart illustrating the contents of an in-cell pressurization control of a second embodiment. The second embodiment differs from the first embodiment in the contents of processes of the in-cell pressurization control. The second embodiment is the same as the first embodiment in other configurations unless otherwise explained.

In the present embodiment, when the in-cell pressurization control is started, first, the controller 500 starts injection of the fuel gas from the injector 240 in step S210. Then, in step S220, the controller 500 starts the operation of the circulation pump 280 in the reverse rotation mode, and in step S230, the controller 500 increases the target value of the rotational speed of the circulation pump 280 in the second rotational direction RD2 by a predetermined amount.

In step S240, the controller 500 determines whether the in-cell pressure change rate exceeds the predetermined first change rate. If the in-cell pressure change rate is not determined to exceed the predetermined first change rate in step S240, the controller 500 returns to the process in step S230 to increase the target value of the rotational speed of the circulation pump 280 in the second rotational direction RD2 by the predetermined amount.

If the in-cell pressure change rate is determined to exceed the predetermined first change rate in step S240, the controller 500 waits for a subsequent process to be started, for a predetermined period of time in step S250. The controller 500 waits for the subsequent process, for example, for one second. Since there occurs a time lag between the change in the rotational speed of the circulation pump 280 and the change in the pressure measured by the pressure sensor 260, it is preferable that the length of time to wait for the subsequent process is determined depending on this time lag.

After waiting for the subsequent process in step S250, in step S260, the controller 500 determines whether the in-cell pressure change rate exceeds a second change rate that is smaller than the first change rate. When the rotational speed of the circulation pump 280 in the second rotational direction RD2 exceeds a predetermined rotational speed, a reverse flow state is caused in which the fuel gas injected from the injector 240 flows from the suction port 256 of the ejector 250 to the circulation pump 280. In the reverse flow state, the amount of fuel gas supplied from the ejector 250 to the fuel gas supply port of the fuel cell 100 decreases, and thus the increased pressure measured by the pressure sensor 260 starts to decrease thereafter. In the present embodiment, the controller 500 determines that the fuel cell system is in the reverse flow state if the in-cell pressure change rate exceeds the first change rate and then decreases to the second change rate or less. The second change rate can be determined by a test performed in advance.

If the in-cell pressure change rate is not determined to exceed the second change rate in step S260, in other words, if the fuel cell system is determined to be in the reverse flow state, the controller 500 decreases the target value of the rotational speed of the circulation pump 280 in the second rotational direction RD2 in step S265. In the present embodiment, the controller 500 decreases the target value of the rotational speed of the circulation pump 280 such that an absolute value of the decrease in the target value of the rotational speed in step S265 is smaller than an absolute value of the increase in the target value of the rotational speed in step S230. After step S265, the controller 500 returns to the process in step S250.

If the in-cell pressure change rate is determined to exceed the second change rate in step S260, in other words, if the fuel cell system is not determined to be in the reverse flow state, the controller 500 determines whether the in-cell pressurization control is to be terminated in step S270. If the in-cell pressurization control is not determined to be terminated in step S270, the controller 500 returns to the process in step S250. On the other hand, if the in-cell pressurization control is determined to be terminated in step S270, the controller 500 stops the rotation of the circulation pump 280 in step S280 and then terminates this process.

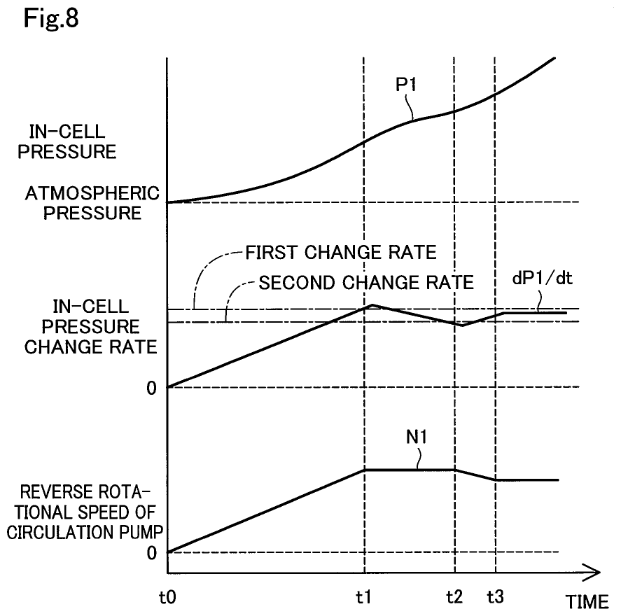

FIG. 8 is a time chart schematically illustrating changes in the in-cell pressure exhibited when executing the in-cell pressurization control. The solid lines in FIG. 8 represent the transitions of the in-cell pressure P1, of the in-cell pressure change rate dP1/dt, and of the rotational speed N1 of the circulation pump 280 in the second rotational direction RD2 in the case of executing the in-cell pressurization control.

Since the in-cell pressure change rate dP1/dt is less than or equal to the first change rate during a period of time from timing t0 to timing t1, the controller 500 increases the rotational speed N1 of the circulation pump 280 in the second rotational direction RD2. As the in-cell pressure change rate dP1/dt exceeds the first change rate at timing t1, the controller 500 stops increasing the rotational speed N1 of the circulation pump 280. Since there occurs a time lag between the change in the rotational speed N1 of the circulation pump 280 and the change in the in-cell pressure change rate dP1/dt, the in-cell pressure change rate dP1/dt still increases by a predetermined amount even after the increase of the rotational speed N1 of the circulation pump 280 is stopped.

In FIG. 8, the reverse flow state is caused at a point in time from timing to timing t2, so that the in-cell pressure change rate dP1/dt starts to decrease, and consequently, the in-cell pressure change rate dP1/dt becomes less than or equal to the second pressure change rate at timing t2. As the in-cell pressure change rate dP1/dt becomes less than or equal to the second change rate, the controller 500 decreases the rotational speed N1 of the circulation pump 280. By decreasing the rotational speed N1 of the circulation pump 280, the reverse flow state is eliminated, whereby the in-cell pressure change rate dP1/dt increases again and then hovers between the second change rate and the first change rate.

According to the fuel cell system 10 of the present embodiment described above, the controller 500 decreases the rotational speed N1 of the circulation pump 280 in the second rotational direction RD2 when the fuel cell system is determined to be in the reverse flow state under the in-cell pressurization control. Thus, the reverse flow state due to an excessively high rotational speed of the circulation pump 280 in the second rotational direction RD2 can be eliminated, thereby effectively increasing the pressure in the unit cell 101.

C. Third Embodiment:

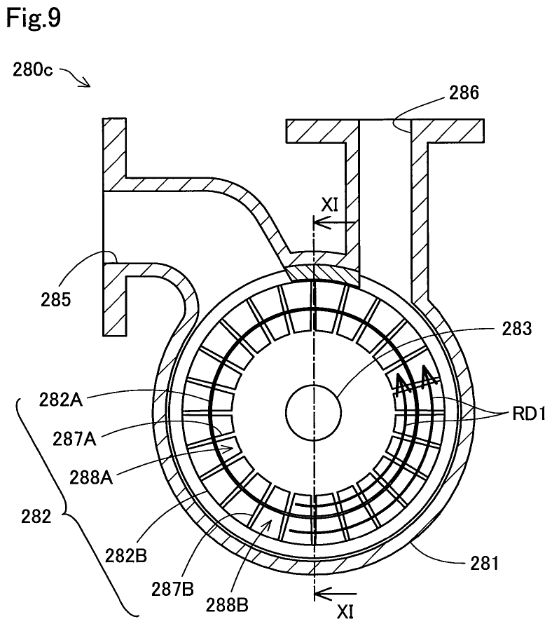

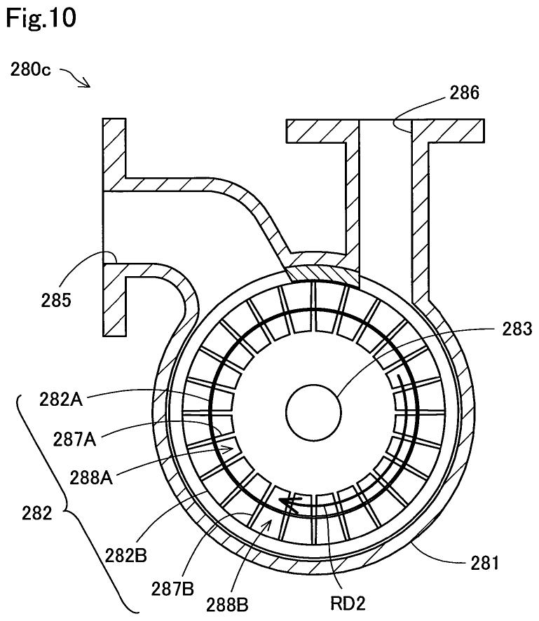

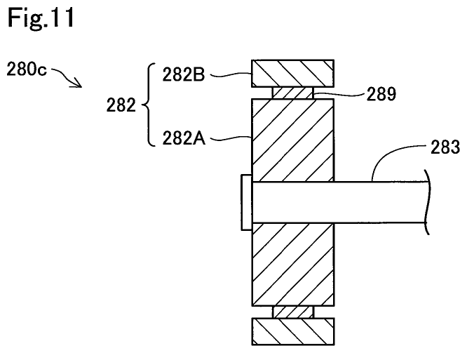

FIG. 9 is a cross-sectional view illustrating a configuration of a circulation pump 280c in a third embodiment. FIG. 10 is an explanatory diagram illustrating a state in which the circulation pump 280c of the third embodiment is operated in a reverse rotation mode. FIG. 11 is a cross-sectional view taken along the line XI-XI in FIG. 9. The third embodiment differs from the first embodiment in the configuration of the circulation pump 280c. The third embodiment is the same as the first embodiment in other configurations unless otherwise explained.

As illustrated in FIG. 9, the circulation pump 280c includes an inner peripheral impeller 282A and an outer peripheral impeller 282B housed in the casing 281. The inner peripheral impeller 282A is configured in a disk shape. An outer peripheral portion of the inner peripheral impeller 282A is provided with guide vanes 287A and grooves 288A. The outer peripheral impeller 282B is configured in a circular shape and is disposed along the outer periphery of the inner peripheral impeller 282A. An outer peripheral portion of the outer peripheral impeller 282B is provided with guide vanes 287B and grooves 288B. As illustrated in FIG. 11, the inner peripheral impeller 282A is connected to the shaft 283, while the outer peripheral impeller 282B is connected to the inner peripheral impeller 282A by a one-way clutch 289 provided on the outer peripheral portion of the inner peripheral impeller 282A.

In the present embodiment, the same in-cell pressurization control as that of the first embodiment illustrated in FIG. 4 or as that of the second embodiment illustrated in FIG. 7 is executed. As illustrated in FIG. 9, when the circulation pump 280c is operated in the forward rotation mode, the one-way clutch 289 transmits a rotational force in the first rotational direction RD1 to the outer peripheral impeller 282B. On the other hand, as illustrated in FIG. 10, when the circulation pump 280c is operated in the reverse rotation mode, the one-way clutch 289 does not transmit a rotational force in the second rotational direction RD2 to the outer peripheral impeller 282B

According to the fuel cell system 10 of the present embodiment described above, the inner peripheral impeller 282A and the outer peripheral impeller 282B can be rotated as one unit when the circulation pump 280c is operated in the forward rotation mode. Thus, even when their rotational speed is low, the circulation pump 280c can be operated with a large capacity and high lifting height. Furthermore, when the circulation pump 280c is operated in the reverse rotation mode, the inner peripheral impeller 282A can be rotated without rotating the outer peripheral impeller 282B. Thus, the inertia moment of the impeller 282 can be reduced to thereby reduce the power consumption when the circulation pump 280c is operated in the reverse rotation mode.

D. Fourth Embodiment:

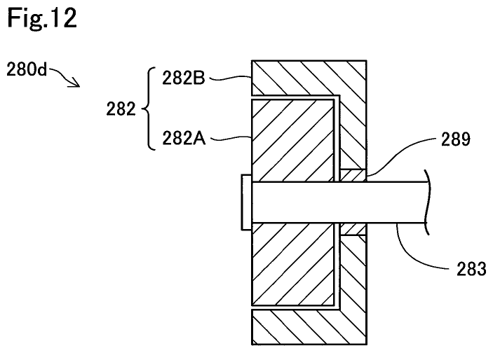

FIG. 12 is a cross-sectional view illustrating a configuration of a circulation pump 280d in a fourth embodiment. In FIG. 12, the section of the circulation pump 280d corresponding to FIG. 11 is represented. The fourth embodiment differs from the third embodiment in the configuration of the circulation pump 280d. The fourth embodiment is the same as the third embodiment in other configurations unless otherwise explained.

In the present embodiment, the outer peripheral impeller 282B of the circulation pump 280d has a circular portion disposed on the outer periphery of the inner peripheral impeller 282A and a disk-shaped portion connected to an inner peripheral part of the circular portion. In the present embodiment, the outer peripheral impeller 282B is connected to the shaft 283 but not to the inner peripheral impeller 282A, via the one-way clutch 289. More specifically, an inner periphery of the disk-shaped portion of the outer peripheral impeller 282B and the shaft 283 are connected by the one-way clutch 289.

According to the fuel cell system 10 of the present embodiment described above, the inner peripheral impeller 282A and the outer peripheral impeller 282B can be rotated as one unit when the circulation pump 280d is operated in the forward rotation mode, whereas the inner peripheral impeller 282A can be rotated without rotating the outer peripheral impeller 282B when the circulation pump 280d is operated in the reverse rotation mode.

E. Fifth Embodiment:

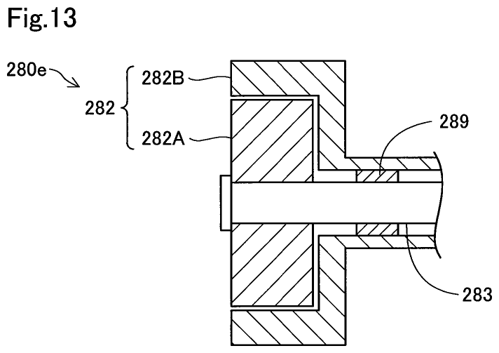

FIG. 13 is a cross-sectional view illustrating a configuration of a circulation pump 280e in a fifth embodiment. In FIG. 13, the section of the circulation pump 280e corresponding to FIG. 11 is represented. The fifth embodiment differs from the third embodiment in the configuration of the circulation pump 280e. The fifth embodiment is the same as the third embodiment in other configurations unless otherwise explained.

In the present embodiment, the outer peripheral impeller 282B of the circulation pump 280e has a circular portion disposed at the outer periphery of the inner peripheral impeller 282A, a cylindrical portion connected to a disk-shaped portion which is disposed at an outer periphery of the shaft 283, and the disk-shaped portion connecting the circular portion and the cylindrical portion together. In the present embodiment, the outer peripheral impeller 282B is connected to the shaft 283 but not to the inner peripheral impeller 282A, via the one-way clutch 289. More specifically, an inner peripheral part of the cylindrical portion of the outer peripheral impeller 282B and the shaft 283 are connected by the one-way clutch 289.

According to the fuel cell system 10 of the present embodiment described above, the inner peripheral impeller 282A and the outer peripheral impeller 282B can be rotated as one unit when the circulation pump 280e is operated in the forward rotation mode, whereas the inner peripheral impeller 282A can be rotated without rotating the outer peripheral impeller 282B when the circulation pump 280e is operated in the reverse rotation mode.

F. Other Embodiments:

(F1) In the fuel cell system 10 of each embodiment described above, the pressure sensor 260 is provided in the fuel gas supply flow path 201 between the ejector 250 and the fuel gas supply port of the fuel cell 100, Alternatively, the pressure sensor 260 may be provided not in the fuel gas supply flow path 201, but in the fuel gas circulation flow path 202 between the fuel gas discharge port of the fuel cell 100 and the gas-liquid separator 270.

(F2) In the fuel cell system 10 of the second embodiment described above, in step S260 of the in-cell pressurization control illustrated in FIG. 7, the controller 500 calculates the in-cell pressure change rate using the pressure measured by the pressure sensor 260 and determines whether the fuel cell system is in the reverse flow state, using the calculated in-cell pressure change rate. Alternatively, in step S260 of the in-cell pressurization control illustrated in FIG. 7, the controller 500 may determine whether the fuel cell system is in the reverse flow state, using the concentration of the fuel gas in the unit cell 101. For example, a concentration sensor that measures the concentration of the fuel gas may be provided in the fuel gas circulation flow path 202 between the fuel gas discharge port of the fuel cell 100 and the gas-liquid separator 270. Since once the reverse flow state is caused, the highly-concentrated fuel gas flows into the fuel gas circulation flow path 202, when the concentration of the fuel gas measured by the concentration sensor exceeds a predetermined value, the controller 500 may determine that the fuel cell system is in the reverse flow state.

(F3) In the fuel cell system 10 of the second embodiment described above, in step S260 of the in-cell pressurization control illustrated in FIG. 7, the controller 500 determines whether the fuel cell system is in the reverse flow state, using the in-cell pressure change rate. Alternatively, the controller 500 may determine that the fuel cell system is in the reverse flow state when the ratio of the amount of power generation in the unit cell 101 on the fuel gas discharge port side of the fuel cell 100 to the amount of power generation in the unit cell 101 on the fuel gas supply port side of the fuel cell 100 exceeds a predetermined value.

(F4) In the fuel cell system 10 of the second embodiment described above, the pressure sensor that measures the pressure to calculate the in-cell pressure change rate in step S240 may be different from the pressure sensor that measures the pressure to calculate the in-cell pressure change rate in step S260.

(F5) In the circulation pump 280d of the fuel cell system 10 of the fourth embodiment and the circulation pump 280e of the fuel cell system 10 of the fifth embodiment as described above, the inner peripheral impeller 282A is connected directly to the shaft 283, while the outer peripheral impeller 282B is connected to the shaft 283 via the one-way clutch 289. Alternatively, in the circulation pump 280d or the circulation pump 280e, the inner peripheral impeller 282A may be connected to the shaft 283 via the one-way clutch 289, while the outer peripheral impeller 282B may be connected directly to the shaft 283.

(F6) In the fuel cell system 10 of each embodiment described above, the injector 240 and the ejector 250 may be integrated together.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) According to one aspect of the present disclosure, a fuel cell system is provided. The fuel cell system includes: a fuel cell; a fuel gas supply flow path for supplying fuel gas from a fuel gas supply source to the fuel cell; a fuel gas circulation flow path for circulating fuel off-gas discharged from the fuel cell to the fuel gas supply flow path; a turbopump disposed in the fuel gas circulation flow path and configured to pressurize and feed the fuel off-gas to the fuel gas supply flow path by rotating in a first rotational direction; an ejector disposed in the fuel gas supply flow path and configured to merge the fuel gas and the fuel off-gas pressurized and fed by the turbopump and to supply merged gas to the fuel cell; and a controller configured to control rotation of the turbopump. The controller rotates the turbopump in a second rotational direction opposite to the first rotational direction in a case of increasing a pressure in the fuel cell to a predetermined pressure using the fuel gas.

According to the fuel cell system of this aspect, the turbopump is rotated in the second rotational direction in the case of increasing the pressure in the fuel cell to the predetermined pressure using the fuel gas, thereby making it possible to suppress the circulation of the fuel off-gas from the fuel cell to the ejector via the turbopump. Thus, the time required to increase the pressure in the fuel cell can be suppressed from being prolonged.

(2) The fuel cell system of the above-described aspect may further include a pressure sensor for acquiring a pressure of the fuel gas in the fuel cell, in which the controller may increase a rotational speed of the turbopump in the second rotational direction if a change rate of the pressure of the fuel gas acquired by the pressure sensor is less than or equal to a predetermined first change rate during a period in which the turbopump is rotated in the second rotational direction.

According to the fuel cell system of this aspect, the rotational speed of the turbopump in the second rotational direction can be suppressed from becoming insufficient. Thus, the circulation of fuel off-gas from the fuel cell to the ejector through the turbopump can be effectively suppressed.

(3) In the fuel cell system of the above-described aspect, the controller may decrease a rotational speed of the turbopump in the second rotational direction when the fuel cell system is determined to be in a reverse flow state where the fuel gas flows from the ejector into the turbopump, during a period in which the turbopump is rotated in the second rotational direction.

According to the fuel cell system of this aspect, the time required to increase the pressure in the fuel cell can be suppressed from being prolonged due to the reduction in the amount of supply of the fuel gas to the fuel cell which is caused by the inflow of the fuel gas from the ejector to the turbopump.

(4) The fuel cell system of the above-described aspect may further include a pressure sensor for acquiring a pressure of the fuel gas in the fuel cell, in which the controller may determine that the fuel cell system is in the reverse flow state if a change rate of the pressure of the fuel gas acquired by the pressure sensor is less than or equal to a predetermined second change rate.

According to the fuel cell system of this aspect, whether the fuel cell system is in the reverse flow state can be determined using the change rate of the pressure of the fuel gas in the fuel cell.

(5) In the fuel cell system of the above-described aspect, the controller may determine whether the fuel cell system is in the reverse flow state, using a concentration of the fuel gas in the fuel cell.

According to the fuel cell system of this aspect, whether the fuel cell system is in the reverse flow state can be determined using the concentration of the fuel gas in the fuel cell.

(6) In the fuel cell system of the above-described aspect, the turbopump may include: a shaft that rotates; an inner peripheral impeller that rotates by a rotational force from the shaft; and an outer peripheral impeller that is disposed on an outer periphery of the inner peripheral impeller and rotates by a rotational force from the shaft, and one of the inner peripheral impeller and the outer peripheral impeller may receive the rotational force from the shaft via a one-way clutch.

According to the fuel cell system of this aspect, only one of the inner peripheral impeller and the outer peripheral impeller can be rotated in the second rotational direction. Thus, the power consumption of the turbopump can be reduced.

The present disclosure can also be realized in various forms other than the fuel cell system. For example, the present disclosure can be realized in the form of a control method of a fuel cell system.

What is claimed is:

1. A fuel cell system comprising:
a fuel cell;
a fuel gas supply flow path configured to supply fuel gas from a fuel gas supply source to the fuel cell;
a fuel gas circulation flow path configured to circulate fuel off-gas discharged from the fuel cell to the fuel gas supply flow path;
a turbopump disposed in the fuel gas circulation flow path and configured to pressurize and feed the fuel off-gas to the fuel gas supply flow path by rotating in a first rotational direction;
an ejector disposed in the fuel gas supply flow path and configured to merge the fuel gas and the fuel off-gas pressurized and fed by the turbopump and to supply merged gas to the fuel cell; and
a controller configured to control rotation of the turbopump,
wherein the controller rotates the turbopump in a second rotational direction opposite to the first rotational direction in a case of increasing a pressure in the fuel cell to a predetermined pressure using the fuel gas.

2. The fuel cell system according to claim 1, further comprising a pressure sensor configured to acquire a pressure of the fuel gas in the fuel cell,
wherein the controller increases a rotational speed of the turbopump in the second rotational direction if a change rate of the pressure of the fuel gas acquired by the pressure sensor is less than or equal to a predetermined first change rate during a period in which the turbopump is rotated in the second rotational direction.

3. The fuel cell system according to claim 1, wherein the controller decreases a rotational speed of the turbopump in the second rotational direction when the fuel cell system is determined to be in a reverse flow state where the fuel gas flows from the ejector into the turbopump, during a period in which the turbopump is rotated in the second rotational direction.

4. The fuel cell system according to claim 3, further comprising a pressure sensor configured to acquire a pressure of the fuel gas in the fuel cell,
wherein the controller determines that the fuel cell system is in the reverse flow state if a change rate of the pressure of the fuel gas acquired by the pressure sensor is less than or equal to a predetermined second change rate.

5. The fuel cell system according to claim 3, wherein the controller determines whether the fuel cell system is in the reverse flow state using a concentration of the fuel gas in the fuel cell.

6. The fuel cell system according to claims 1,
wherein the turbopump includes: a shaft that rotates; an inner peripheral impeller that rotates by a rotational force from the shaft; and an outer peripheral impeller that is disposed on an outer periphery of the inner peripheral impeller and rotates by a rotational force from the shaft, and
wherein one of the inner peripheral impeller and the outer peripheral impeller receives the rotational force from the shaft via a one-way clutch.

7. A control method of a fuel cell system, comprising:
pressurizing and feeding, to an ejector, fuel off-gas discharged from a fuel cell by rotating a turbopump in a first rotational direction while supplying fuel gas from a fuel gas supply source to the fuel cell through the ejector, thereby merging the fuel gas and the fuel off-gas by the ejector to supply merged gas to the fuel cell; and
rotating the turbopump in a second rotational direction opposite to the first rotational direction while supplying the fuel gas from the fuel gas supply source to the fuel cell through the ejector when increasing a pressure in the fuel cell to a predetermined pressure using the fuel gas.

8. The control method of a fuel cell system according to claim 7, wherein
the rotating increases a rotational speed of the turbopump in the second rotational direction if a change rate of the pressure of the fuel gas in the fuel cell acquired by a pressure sensor is less than or equal to a predetermined first change rate during a period in which the turbopump is rotated in the second rotational direction.

9. The control method of a fuel cell system according to claim 7, wherein
the rotating decreases a rotational speed of the turbopump in the second rotational direction when the fuel cell system is determined to be in a reverse flow state where the fuel gas flows from the ejector into the turbopump, during a period in which the turbopump is rotated in the second rotational direction.

10. The control method of a fuel cell system according to claim 9, wherein
the rotating determines that the fuel cell system is in the reverse flow state if a change rate of the pressure of the fuel gas in the fuel cell acquired by a pressure sensor is less than or equal to a predetermined second change rate.

11. The control method of a fuel cell system according to claim 9, wherein
the rotating determines whether the fuel cell system is in the reverse flow state using a concentration of the fuel gas in the fuel cell.
